(19) United States
(12) Patent Application Publication
(10) Pub. No.: US 2017/0332103 A1
(43) Pub. Date: Nov. 16, 2017

(54) INTERLEAVING LUMA AND CHROMA COEFFICIENTS TO REDUCE THE INTRA PREDICTION LOOP DEPENDENCY IN VIDEO ENCODERS AND DECODERS

(71) Applicant: Intel Corporation, Santa Clara, CA (US)

(72) Inventors: Iole Moccagatta, San Jose, CA (US); Atthar H. Mohammed, Folsom, CA (US); Wen Tang, Saratoga, CA (US)

(73) Assignee: Intel Corporation, Santa Clara, CA (US)

(21) Appl. No.: 15/276,268

(22) Filed: Sep. 26, 2016

Related U.S. Application Data
(60) Provisional application No. 62/335,957, filed on May 13, 2016.

(51) Int. Cl. H04N 19/61; H04N 19/436; H04N 19/186; H04N 19/91; H04N 19/159

(52) U.S. Cl. CPC H04N 19/61; H04N 19/91; H04N 19/159; H04N 19/186; H04N 19/436

(57) ABSTRACT

Interleaving luma and chroma coefficients is described in video encoders and decoders. One example includes generating a residual unit of an input video, the residual unit having a predictive unit with luminance samples and transform blocks having chrominance samples, interleaving luminance and chrominance samples of the residual unit, reconstructing the interleaved luminance and chrominance samples in parallel for intra-frame prediction, adding the reconstructed samples to a bitstream of other units generated from the input video, and entropy encoding the bitstream to produce an encoded video bitstream.

### CROSS-REFERENCE TO RELATED APPLICATIONS

The present application claims priority to prior provisional application Ser. No. 62/335,957, filed May 13, 2016, entitled INTERLEAVING LUMA AND CHROMA COEFFICIENTS TO REDUCE THE INTRA PREDICTION LOOP DEPENDENCY IN VIDEO ENCODERS AND DECODERS, by Iole Moccagatta, et al., the disclosure of which is hereby incorporated by reference herein.

### FIELD

The present description relates to video encoding and decoding and in particular processing luminance and chrominance samples.

### BACKGROUND

Video transmission and storage is typically performed with the video encoded in order to reduce the amount of data that must be transmitted or stored. Many encoding relies on the common characteristic that many video frames are very similar to the frames immediately before and after. The background and many foreground elements may be the same and even primary element only move or change very little from frame to frame. After the common parts of two frames are eliminated, the residual unit (RU) is encoded separately. The RU may include motion vectors to indicate a direction of movement for elements of the RU.

As digital video transmission advances, more advanced coding schemes allow for higher resolution and more detailed video to be transmitted and stored. These more advanced coding systems require more digital processing to encode and decode the sequence of frames and larger buffers to store intermediate results while the frames are being encoded or decoded.

Many digital video encoding systems use intra-frame prediction, inter-frame prediction or both. Inter-frame prediction relates to common elements that occur in two or more different successive frames. To decode or encode using inter-frame prediction the affected frames must all be buffered and analyzed before the process may complete. Intra-frame prediction relates to elements that occur in different parts of a single frame.

The present description relates to implementations of the Alliance for Open Media (AOM) codecs. The first codec planned for release by AOM is AOM Version 1 (AV1). Support for HW acceleration of AV1 is planned for Media Gen11. The present description is also related to HEVC/H.265 (High Efficiency Video Codec/H.265 are codecs defined by IUT-T (International Telecommunication Union-Telecommunication standardization sector)) and all its extensions (HEVC RExt, etc.) and profiles, VP9 and all its extensions and profiles. The described structures and techniques may also be applied to codec(s) in which intra prediction is done in the transform domain (i.e. MPEG-4 Part 1, etc.). Intra-frame prediction loop dependency impacts both video decoders and encoders, so that the described structures and techniques apply to both decoders and encoders.

### BRIEF DESCRIPTION OF THE DRAWING FIGURES

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity.

FIG. 1 is a diagram of a residual unit (RU) with a square predictive unit (PU) and transform blocks suitable for 4:2:0 video.

FIG. 2 is a diagram of the RU of FIG. 1 shown intra-prediction loop dependency.

FIG. 3 is a diagram of the RU of FIG. 1 showing a processing order of luma and chroma samples.

FIG. 4 is a diagram of a processing pipe for processing the RU of FIG. 1 in the order shown in FIG. 3.

FIG. 5 is a diagram of a processing pipe for processing the RU of FIG. 1 with luma and chroma interleaving according to an embodiment.

FIG. 6 is a diagram of the RU of FIG. 1 showing the processing order of luma and chroma samples of FIG. 3 on the left and an interleaved processing order on the right according to an embodiment.

FIG. 7 is a diagram of an RU for 4:2:0 video showing a serial processing order of luma and chroma samples on the left and an interleaved processing order on the right according to an embodiment.

FIG. 8 is a diagram of an RU for 4:2:0 video in which the PU and transform size are the same showing a serial processing order.

FIG. 9 is a diagram of another RU for 4:2:0 video showing a serial processing order of luma and chroma samples on the left and an interleaved processing order on the right according to an embodiment.

FIG. 10 is a diagram of another RU for 4:2:0 video showing a serial processing order of luma and chroma samples on the left and an interleaved processing order on the right according to an embodiment.

FIG. 11 is a diagram of an RU for 4:2:2 video showing a serial processing order of luma and chroma samples on the left and an interleaved processing order on the right according to an embodiment.

FIG. 12 is a diagram of an RU for 4:4:4 video showing a serial processing order of luma and chroma samples on the left and an interleaved processing order on the right according to an embodiment.

FIG. 13 is a diagram of another RU for 4:2:0 video showing a serial processing order of luma and chroma samples on the left and a pairwise interleaved processing order on the right according to an embodiment.

FIG. 14 is a diagram of another RU for 4:2:0 video showing a serial processing order of luma and chroma samples on the left and a triplet interleaved processing order on the right according to an embodiment.

FIG. 15 is a diagram of a video encoder according to an embodiment.

FIG. 16 is a diagram of a video decoder according to an embodiment.

FIG. 17 is a block diagram of a computing device video encoding and decoding according to an embodiment.

### DETAILED DESCRIPTION

Embodiments described herein change the interleaving of luma (Y) or luminance and chroma (Cb and Cr) or chrominance coefficients to reduce the intra prediction loop dependency. This dependency exists in all video codec(s) which use intra prediction. The described embodiments assume the intra prediction is done in the pixel domain, such as in HEVC/H.265 and all its extensions (HEVC RExt, etc.) and profiles, VP9 and all its extensions and profiles, AOM's AV1 and all its extensions and profiles. Embodiments may also be applied to codec(s) where intra prediction is done in the transform domain (i.e. MPEG-4 Part 1, etc.). The intra prediction loop dependency impacts both the decoder and the encoder, so the described techniques apply to both.

Described embodiments interleave Y and Cb/Cr on a Residual Unit basis (RU), where a RU represents a square block of samples processed by the square transform. Because intra-frame prediction reconstruction is done across RU boundaries, this interleaving allows intra prediction reconstruction of Y, Cb, and Cr samples to progress in parallel, thus reducing the intra-frame prediction loop latency. Intra-frame prediction loop latency reduction ranges from 30% to 55%, depending on the transform size.

Embodiments are described for the case of intra prediction done in the pixel domain. Embodiments may also be applied to intra prediction done in the transform domain. Also, the examples used in the present description of the basic principle assume 4:2:0 chroma sampling. Embodiments may also be applied to other chroma sampling rates, such as 4:2:2 and 4:4:4, and to monochrome. While the basic principles are described using a video encoder as a use case. Embodiments may be applied to both video decoders and video encoders.

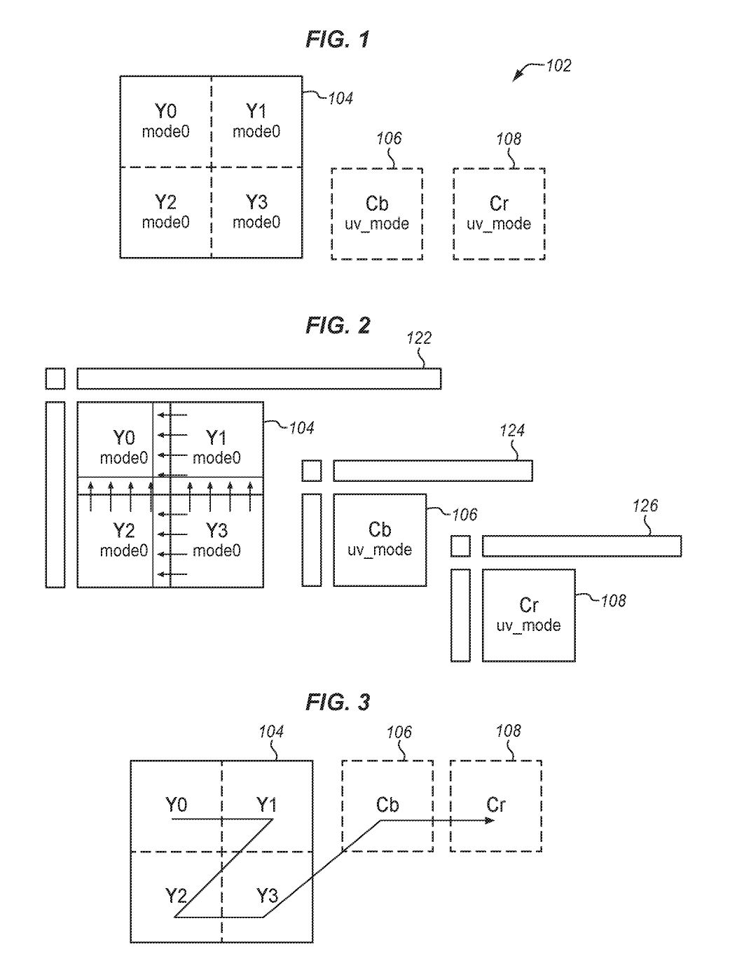

Intra prediction is done across a Residual Unit (RU), where the RU represents a square block of samples processed by a square transform. As an example, FIG. 1 is a diagram of an RU 102 with a 4:2:0 square Prediction Unit (PU) 104 shown in continuous line having four parts Y0, Y1, Y2, Y3. The RU also has two transform blocks 106, 108 shown in dashed line representing Cb and Cr, respectively. The PU 104 size is larger than the txfm (transform) 106, 108 size.

FIG. 2 is a diagram of the RU of FIG. 1 showing an intra prediction loop dependency using arrows. The Y0 reconstructed samples are used by the intra prediction reconstruction of Y1 and Y2 samples. Y0, Y1, and Y2 reconstructed samples are used by the intra prediction reconstruction of Y3 samples. Intra prediction creates the dependency and is used in many video codecs. The intra prediction loop dependency affects both video encoders and video decoders.

FIG. 3 is a diagram of the RU of FIG. 1 showing the order of the luma and chroma samples using arrows. Starting with Y0 and then proceeding through Y1, Y2, and Y3 in that order, all the 4 luma samples (Y0, Y1, Y2, and Y3), are followed by all the chroma samples (Cb, Cr). Because of this order, the reconstruction of the Cb and Cr samples cannot start until all the luma samples have been received. In other words, the chroma processing pipe is idle until the luma processing is completed. This is true regardless of the level of detail from the illustrated 4:2:0 to 4:4:4.

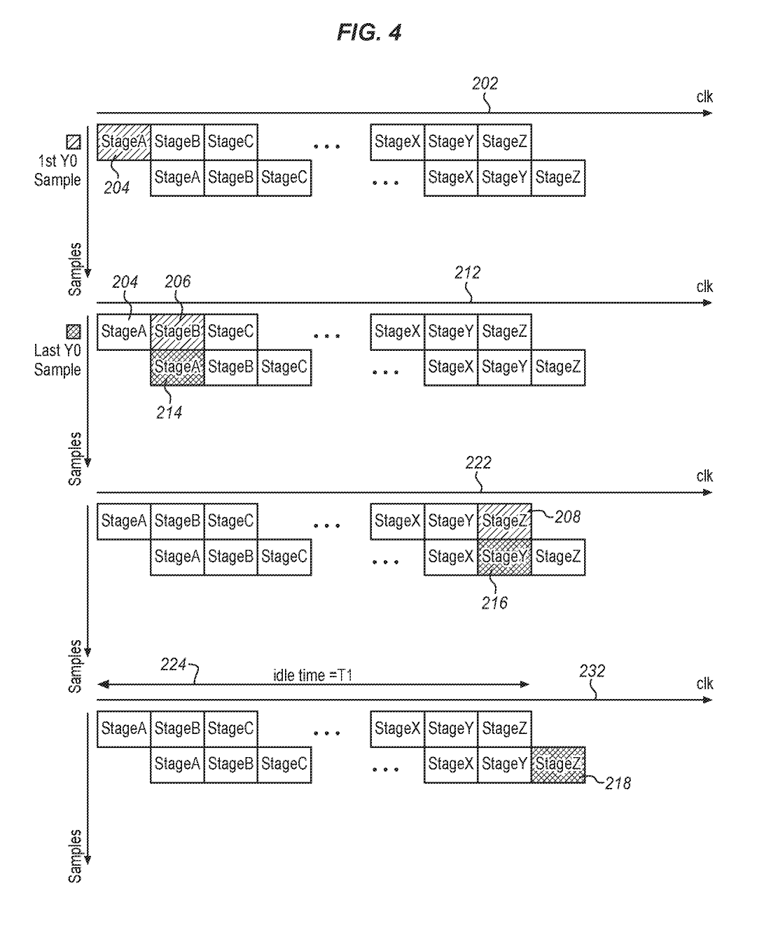

In addition, the smaller the transform block, the larger the gap during which the processing pipe is idle. The gap is the number of clk (clock) pulses that it takes for the last samples of the txfm (“last Y0 sample” in FIG. 4) to travel the entire pipeline. FIG. 4 is a diagram of a processing pipe in which processing stages are activated over time from left to right. Each horizontal line represents a different time during the processing. The first line 202 represents the start of processing in which a first Stage A 204 is active in processing the first Y0 sample. No other processing, shown as additional stages, is active because other processes are waiting for the results from the first Stage A.

The second line 212 corresponds to a later time at which the last Y0 sample is being processed. In this case, the top row Stage A 204 is completed and has passed results to Stage B 206 and to a second row Stage A 214 which operates in parallel in the pipe with the top row. The third line represents a much later time at which the processing of Y0 is almost completed. This is indicated as the first row reaching Stage Z 208. The second row has reached Stage Y 216 in parallel and in the fourth line 232, Stage Z is finished in the first row and Stage Z 218 in the second row is completing its processing. The pipe may then begin processing the Y1 samples.

The diagram of FIG. 4 is provided as an illustration to show the impact of the delay. While there are 26 different processing stages from A to Z and two parallel rows of processing, in an actual encoding or decoding process, there may be any other number of stages and rows of processing. While only four rows are shown, there will be 27 states as the each row work through all 26 processing states.

As shown in FIG. 4, there is an idle time T1 shown as arrow 224 between when the first Y0 sample is received at the first line 202 and when the first Y1 sample can be received after the fourth line 232 is finished. FIG. 4 shows an example in which the txfm size=4×4. The delay may be greater for a larger PU such as PU=8×8 and for a rectangular PU>=16×8 or 8×16. Embodiments described herein fill in that gap with samples whose processing does not depend on the reconstructions of the samples currently in the pipe.

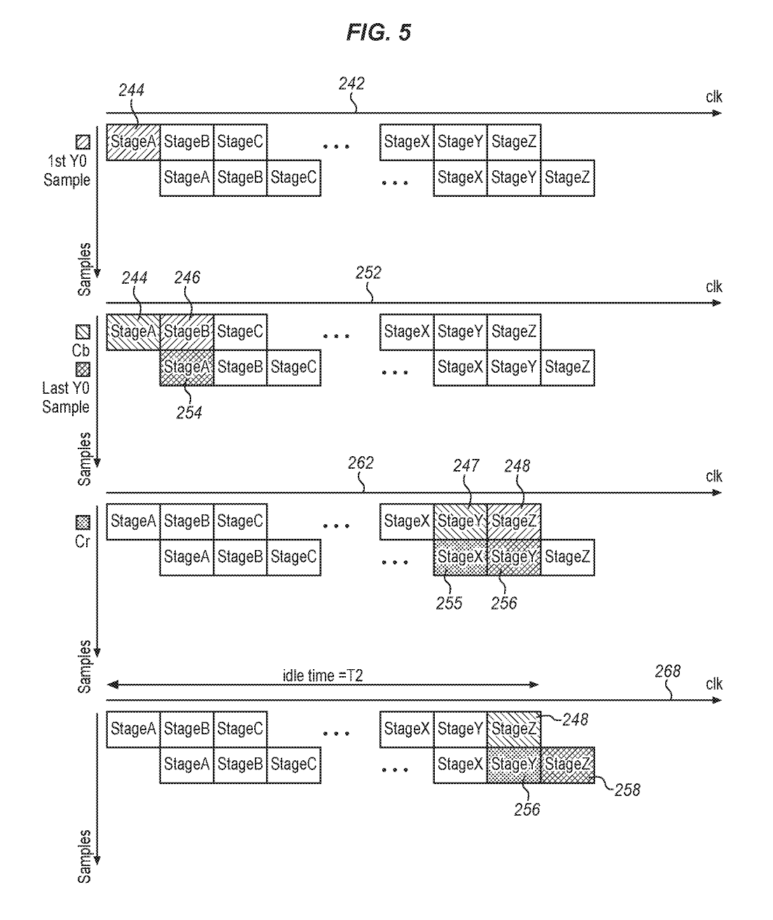

FIG. 5 is a diagram of parallel processing similar to that of FIG. 4 but in which Cb and Cr processing may begin before the end of the Y0 processing. At a first time indicated by a time line 244 at the top of the diagram, the first Y0 sample is received at Stage A 244 of the top row. This processing is similar to the first time 202 of FIG. 4. However at the next time 252 when the last Y0 sample is received and is being processed in Stage A 254 of the second row, a sample is also received at Stage A 244 of the first row. While the Y0 samples are being processed in the first and second rows at Stage B 246 and Stage A 254, respectively, processing begins in the first row at Stage A 244 for the first Cr sample.

Similarly, at the third time 262, processing continues with Cb on the first row at Stage Y 247 while processing is being finished in the same row for Y0 in Stage Z 248. At the same time Cb has been introduced to the second row at an earlier time and has progressed to Stage X 255 of the second row. Processing of Y0 has progressed through to Stage y 256 of the second row. At the last indicated time 268, the Cb has moved to Stage Z 248 of the first row and will be completed at the next clock cycle. The Y0 has moved to Stage Z of the second row and will also be completed at the next clock cycle. Cr has progressed to Stage Y 256 of the second row and will be completed after two more clock cycles.

As a result, there is a higher utilization of the processing stages and the parallel functionality of the system. The idle time T2 is much less and the results of the process are delivered sooner.

For a video encoder use case, the processing of the samples after the transform processing unit and before being added to the bit stream is not necessarily affected or changed. Samples-to-bin/bit processing may be used as the last stage of the video encoder processing, such as multi-level or binary entropy/arithmetic encoders, etc. Such last processing stages are not necessarily changed. Only the order in which samples are input to such a last processing stage is changed. As a result the order of the coefficients in the bit-stream also does not require change.

For a video decoder use case, processing symmetric to that described above for the video encoder use case may be used. Therefore, for the video decoder use case there need be no impact or effect on how the samples are processed after being extracted from the bit-stream and before being processed by an inverse transform processing unit. As with the encoder only the order in which bin/bit are input to the bin/bit-to-samples processing is changed.

As a result of the changes shown in FIG. 5, the intra prediction loop latency may be reduced. This improves overall performance in terms of the total number of pixels that are processed per clock cycle. The reduction may range from 30% to 55%. The reduction percentage depends on the transform size. Examples of performance improvements are reported in pixels/clk are shown in Table 1.

In Table 1, the results are normalized to a PU size of 32×3. This allows the results to be compared across all three different PU sizes. As an example, the actual estimated performance improvement for a TU with Size 16×16 has been multiplied by 4 in the Table because one PU Size 32×32 contains 4 TU Size 16×16. In other words, the processing of a single PU Size 32×32 produces the same results as processing four PU Size 8×8.

TABLE 1

| | | Estimated performance improvement [pixel/clk] | | | |
|---|---|---|---|---|---|
| | | TU Size | TU Size | TU Size | TU size |
| | | 32 × 32 | 16 × 16 | 8 × 8 | 4 × 4 |
| PU Size | 32 × 32 | No change | 61% | 134% | 114% |
| | 16 × 16 | N/A | No change | 104% | 110% |
| | 8 × 8 | N/A | N/A | No change | 80% |

### FIRST EXAMPLE

The principles described above may be applied in a variety of different ways, which are denoted as examples herein. A first example is better understood with reference to FIG. 2. As depicted by the large borders 122, 1214, 126 in FIG. 2, the reconstruction of the Cb and Cr chroma samples does not depend on the reconstruction of the corresponding luma samples (Y0, Y1, Y2, and Y3). Therefore luma samples may be reconstructed in parallel with chroma samples. In other words, in the same number of cycles that it takes to reconstruct Y0, the Cb samples may also be reconstructed. Similarly, the Y1 samples may be reconstructed while the Cr samples are reconstructed.

More specifically, as shown in FIG. 5, each luma block of transformed samples may be followed by one or more chroma blocks of transformed samples until all of the chroma blocks have been scanned. The remaining luma blocks, if any may then be sent. In other words, first as many pairs of “Y and Cb/Cr” are sent as possible, then the “Y only” for the remaining clocks. In the case of 4:4:4 there are no “Y only” remaining.

Given this general technique of interleaving luma and chroma, there are two additional variations, based on how many chroma blocks are paired with each one luma block:
(a) pair one chroma block with each luma block
(b) pair two chroma blocks with each luma block.

These variations are described in more detail below.

First Example, Variation (a)

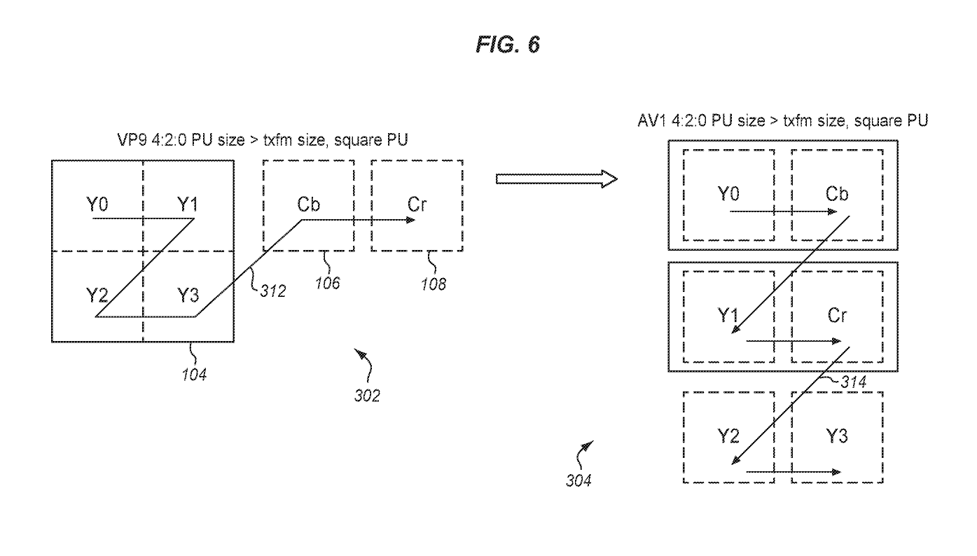

The order of luma and chroma samples for the example of FIG. 3 above (i.e. 4:2:0 square PU with PU size larger than txfm size) may be modified as depicted in FIG. 6. Using this interleaving of luma and chroma samples, the samples within the green box are reconstructed in parallel.

FIG. 6 is a diagram of two different sequences for processing a square PU. The left side of FIG. 6 shows the same PU 302 with the same process ordering as in FIG. 3 indicated by an arrow 312 through each block. On the left side as in FIG. 3, the Y0, Y1, Y2, Y3 are processed first then the Cb and finally Cr. This is changed on the right side of FIG. 6 with a different ordering of the same block 304 as indicated by a different arrow 314. First the Y0 and then Cb are processed, then the Y1 and Cr, then the Y2 and Y3 in that order. The samples in each box are processed in parallel so that (Y0, Cb) are processed in parallel, followed by (Y1, Cr), then (Y2, Y3). While they are processed in parallel, FIG. 5 shows that the Y component starts and is then immediately followed by the C component that has been paired with it.

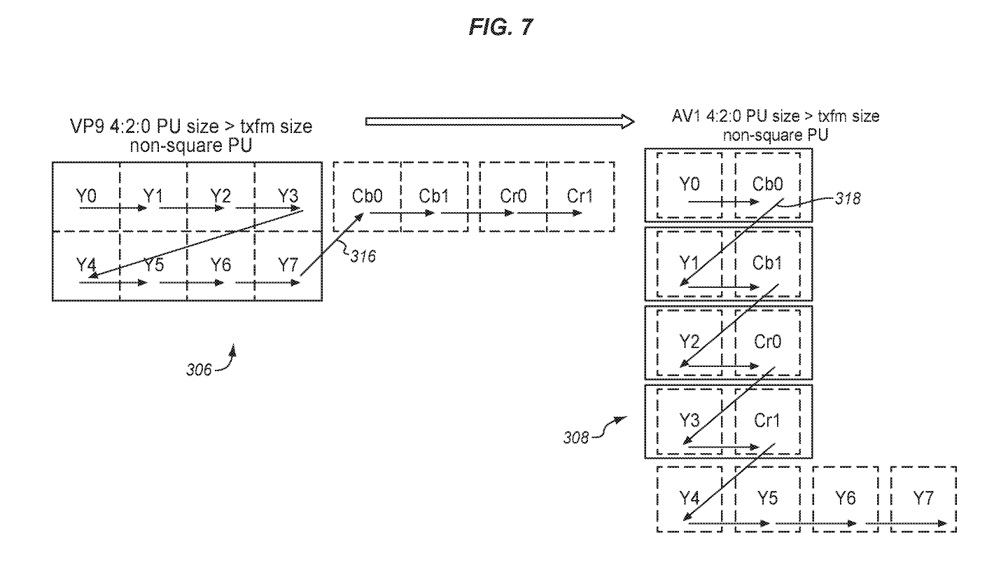

For the same to happen in the case of a 4:2:0 rectangular PU with a PU size larger than the txfm size, the order of luma and chroma samples may be modified as depicted in FIG. 7. FIG. 7 is a diagram of a rectangular 4:2:0 PU in which the PU size is larger than the txfm size. This shows another example of using an interleaving of luma and chroma samples, the samples within the green box on the right side of FIG. 7 are reconstructed in parallel.

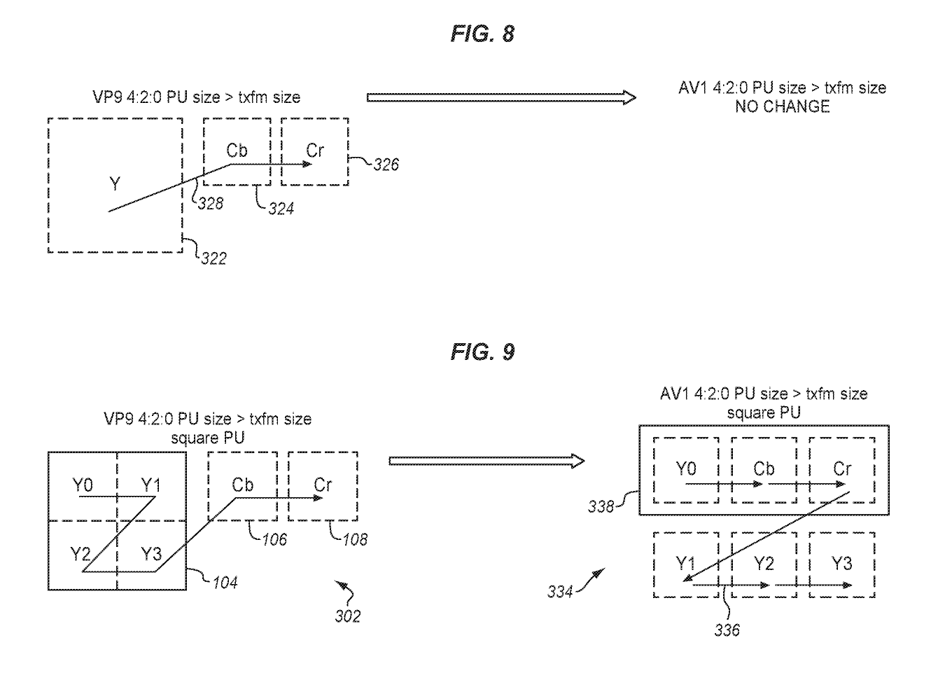

The left side of FIG. 7 shows conventional serial processing by arrow 316 in which all of the Y's in the PU 306, in this case Y0 to Y7, are processed first in sequence and then the transform. These Y's are followed first by each of the Cb's, Cb0, Cb1, and then finally the Cr's, Cr0, Cr1. On the right side of FIG. 7, a reduced latency parallel processing order 318 pairs a luma, Y, component with a chroma, Cb, or Cr. As a result both types of video are processed on the right side in the amount of time that it takes to process the luma alone on the left side. Note that for the case of 4:2:0 PUs with a PU size the same as the txfm size, the order of the luma and chroma samples is not modified. This is shown in FIG. 8. FIG. 8 is a diagram of a 4:2:0 PU 322 and transform 324, 326 and a processing order 328 in which Y is processed first followed by Cb and then Cr. This interleaving can be extended to 4:2:2 and 4:4:4.

First Example, Variation (b)

Variation (b) is similar to variation (a), except that 2 chroma blocks follow each luma block. In the case of the example above as shown in FIG. 6, a 4:2:0 square PU with PU size larger than txfm size, the interleaving order may be modified as depicted in FIG. 9. Using this interleaving of luma and chroma samples, the samples within the green box are reconstructed in parallel.

FIG. 9 is a diagram of a 4:2:0 square PU with a PU size larger than the txfm size. The left side of shows a processing order that might be used in VP9 in which the Ys of the PU 104 are processed first, followed by Cb 106 and then Cr 108. The right side 334 shows parallel processing inside the bounding box 338. As a result Y0, Cb, and Cr are all processed at the same time or in parallel. Y1, Y2, and Y3 are then processed in series in that order.

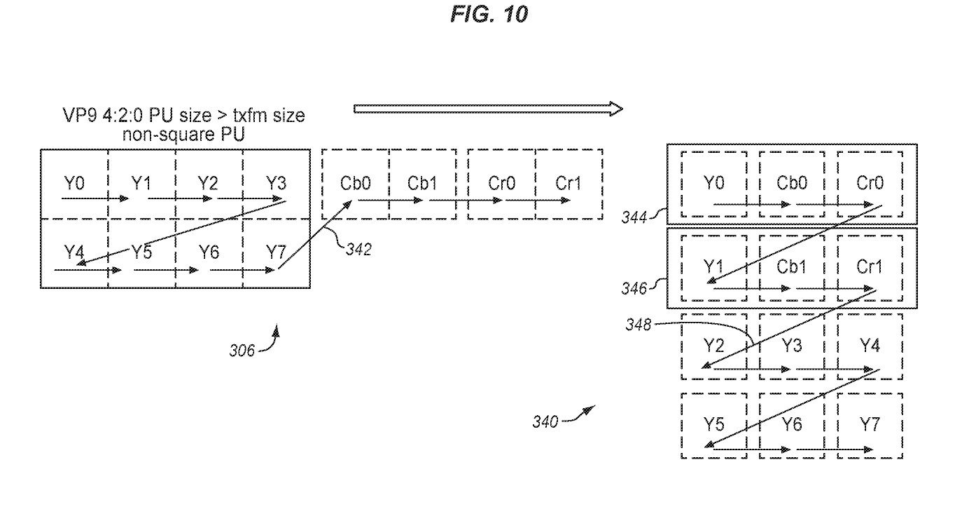

For the same to happen in the case of a 4:2:0 rectangular PU (where PU size is bigger than txfm size), the order of luma and chroma samples may be modified as shown in FIG. 10. FIG. 10 is a diagram of a 4:2:0 rectangular PU 306 similar to that of FIG. 7 with a processing order 342 that is also similar. The Ys are processed first from Y0 to Y7 and then the Cb's, Cb0, Cb1 and then the Cr's, Cr0, Cr1.

On the right side the blocks are rearranged to pair a luma component Y with each of the two chroma components Cb0, Cr0. These are indicated as within a bounding box 344 and are processed in parallel starting with the first luma sample and then proceeding to the first chroma sample and then the next chroma sample. After this the next luma sample Y1 is paired with corresponding chroma samples Cb1, Cr1 as shown in the next bounding box 346. With the chrominance fully processed, the remaining luma samples are then processed in order. Using this interleaving of luma and chroma samples, the samples within each bounding box 344, 346 are reconstructed in parallel.

FIG. 10 shows the conventional processing on the left side as on the left side of FIG. 7. On the left side, the luma coefficient from Y0 to Y8 are processed first, then the Cb and the Cr coefficients are processed. The right side shows that items in the boxes may be processed in parallel. In this case, Y0, Cb0, and Cr0 are processed in parallel, then Y1, Cb1, and Cr1 are processed in parallel. This is followed by the remaining luma processing from Y2, to Y7 in series. In this second variation the parallel processing is done in triplets, as compared to the first variation in which there are pairs. On the right side, processing is completed in the time that it takes to process only the luma coefficients on the left side. This may be performed for any PU structure but provides a greater improvement in processing times when there are more chroma values such as with 4:2:2 or 4:4:4.

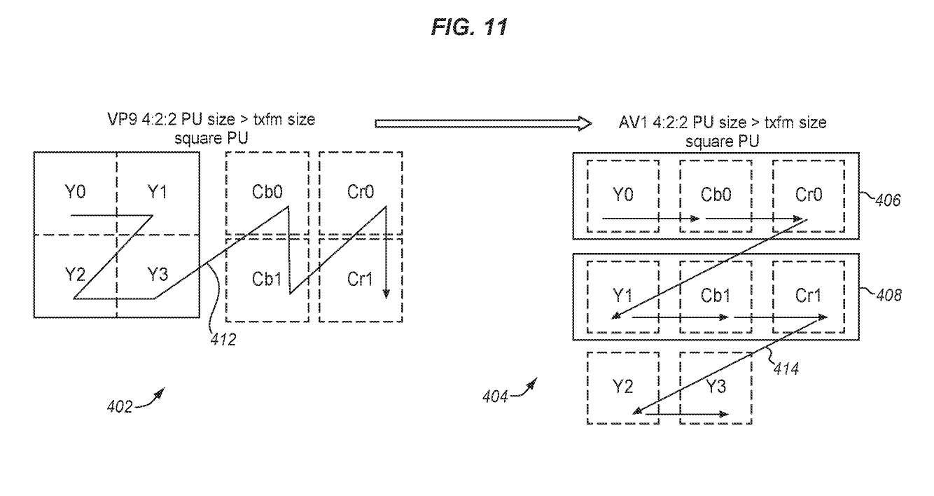

FIG. 11 is a diagram of a square 4:2:2 PU with a size great than the transform size. In this case there are two of each chroma value. The left side of the diagram shows a processing order 412 that may be applied to the PU 402 in VP9 with each luma Y0-Y3 processed, followed by the Cb blocks Cb0, Cb1, followed by the Cr blocks Cr0, Cr1.

On the right side the same PU 404 may be processed in parallel triplets with the first triplet shown in the first bounding box 406 starting with Y0, followed by Cb0 and Cb1. These are processed in parallel in the manner shown in FIG. 5. When Y0 is finished processing, then the next triplet is processed as shown in the next bounding box 408 starting with Y1, then Cb1, then Cr1. This triplet is followed by the remaining luma blocks Y2, Y3. As a result, the entire PU is processed in the same amount of time that would be required for luma alone.

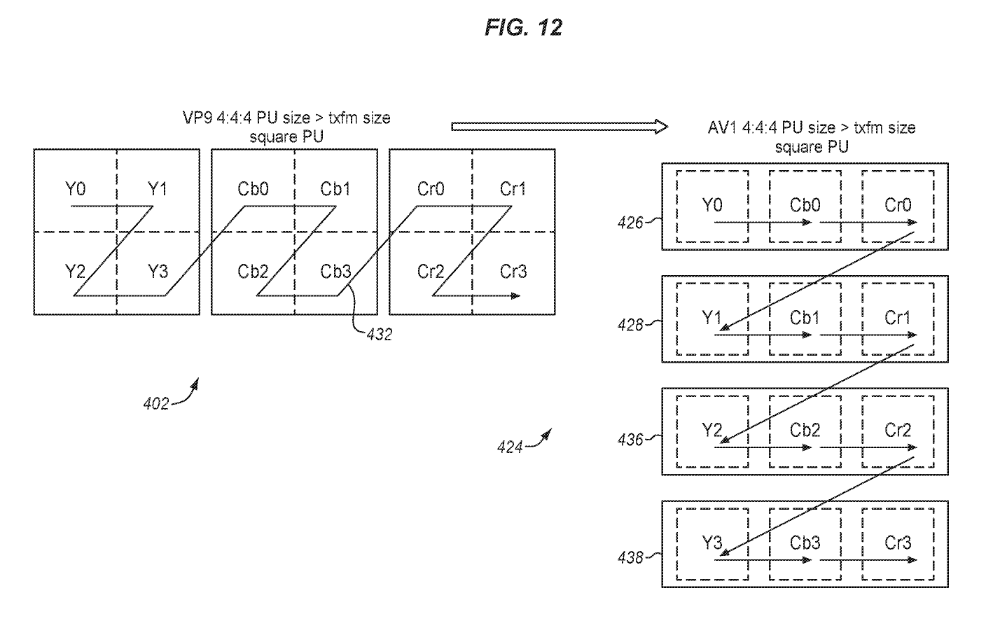

FIG. 12 is a diagram of a square 4:4:4 PU with a size great than the transform size. In this case there are four of each chroma value, yet the PU is processed using only two more clocks than would be used for a 4:2:0 PU. The left side of the diagram shows a processing order 432 for the PU 422 that may be used in VP9 with each luma Y0-Y3 processed, followed by the Cb blocks Cb0-Cb3, followed by the Cr blocks Cr0-Cr3.

On the right side the same PU 424 may be processed in four parallel triplets instead of the two parallel triplets for 4:2:2 or the single parallel triplet for 4:2:0. The first triplet shown in the first bounding box 426 starts with Y0, followed by Cb0 and Cb1. These are processed in parallel in the manner shown in FIG. 5. When Y0 is finished processing, then the next triplet is processed as shown in the next bounding box 428 starting with Y1, then Cb1, then Cr1. The third triplet shown in the third bounding box 436 starts with Y2, followed by Cb2 and Cb2. These are followed, when Y2 is finished processing, with the next or last triplet is processed as shown in the next bounding box 438 starting with Y3, then Cb3, then Cr3. Since there are no more luma blocks the processing goes to the next frame. This approach may be extended to other formats and structures.

### EXAMPLE 2

Example 2 uses TU geometry where the txfm size of the chroma samples is half that of the luma samples, except for a txfm size of 4×4. In this geometry, each luma block is paired to one Cb and one Cr block. When the txfm size is 4×4, 4 luma blocks (each of size 4×4) are paired to one Cb block (of size 4×4) and one Cr block (of size 4×4).

This change affects the following PU and txfm configurations:
1) square PU with size >8×8 and PU size >txfm size (see FIG. 11)
2) rectangular PU with size >=8×16/16×8

For these configurations, example 2 changes the size of the transform applied to the chroma samples. Some details of example 2 are shown and described below.

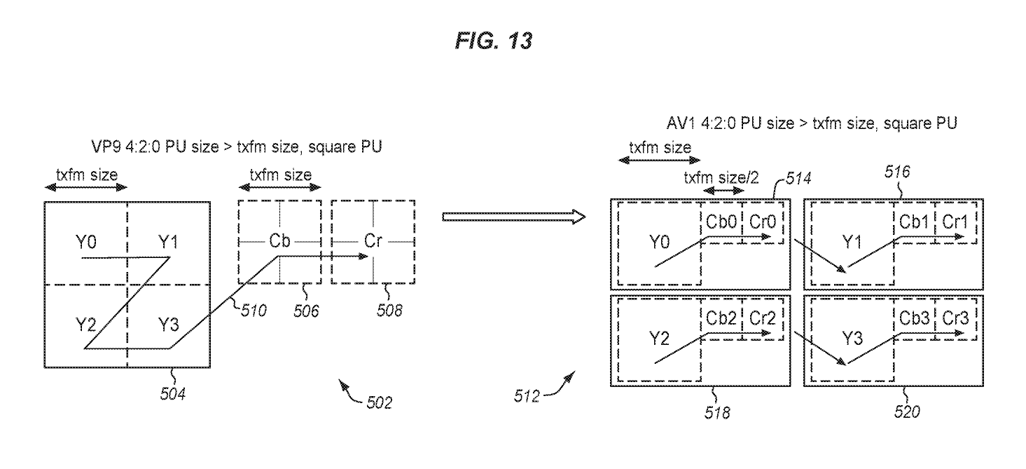

For a square PU of a size bigger than 8×8 and PU size >txfm size, luma and chroma samples may be interleaved in the same way as described in HEVC/H.265. As an example, FIG. 13 is a diagram of a frame 502 with a PU 504 and chroma transforms Cb 506 and Cr 508. The 4:2:0 square PU has a PU size bigger than the txfm size. Conventional processing 510 starts with Y0 through Y3 and then processes the transform after the PU is completed.

The processing may be modified, as shown on the right, into four parallel process stages. The samples within the bounding boxes 514, 516, 518, 520 are reconstructed in parallel. One Y, one Cb, and one Cr component is processed at each stage. After four such stages, Y0-Y3, Cb0-Cb3, and Cr0-Cr3 are all processed, with each component being processed in series, but in parallel with each other component. After four such stages, Y0-Y3, Cb0-Cb3, and Cr0-Cr3 are all processed, with each component being processed in series, but in parallel with each other component. The divisions for Cr and Cb are used to indicate the different parts of the chroma values. This processing is similar to that in FIG. 12 and shows how the process for a 4:4:4 PU may be adapted to a 4:2:0 PU.

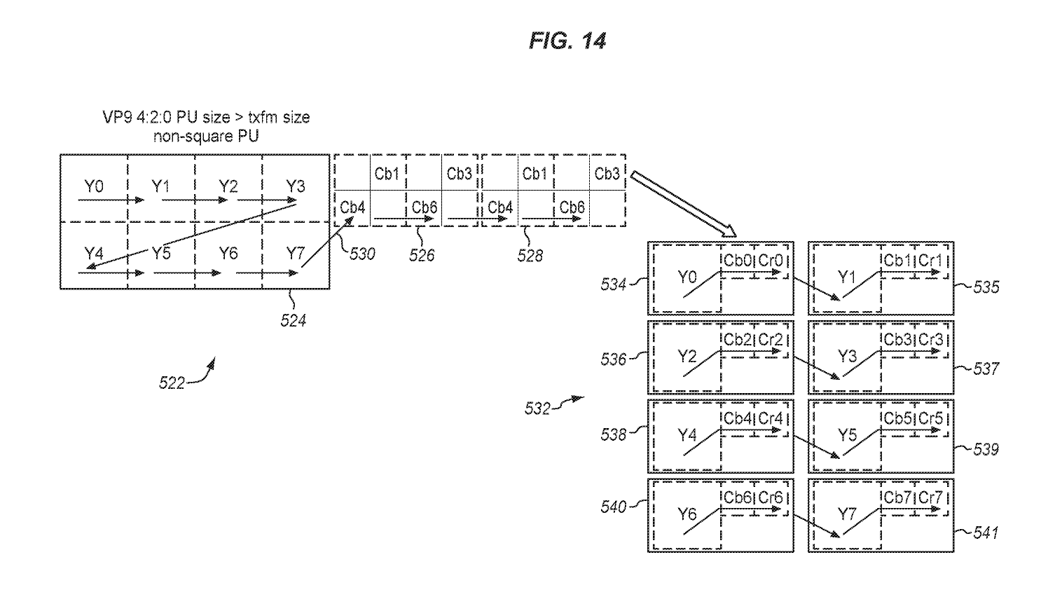

For a rectangular PU (where the PU size is bigger than the txfm size), the order of luma and chroma samples may be modified as depicted in FIG. 14. Using this interleaving of luma and chroma samples, the samples within the bounding boxes are reconstructed in parallel. This specific configuration of a rectangular PU coded using two or more transform blocks does not exist in HEVC/H.265 but may be useful in other encoding or decoding systems.

In FIG. 14, the rectangular 4:2:0 PU 524 has eight luma samples Y0-Y7 and also has chroma transforms 526, 528. The conventional processing 530 on the left side is for all of the luma samples Y0-Y7 to be processed first followed by all of the chroma samples. The processing may be modified, as shown on the right side, into eight parallel process stages 534, 535, 536, 537, 538, 539, 540, 541. One Y, one Cb, and one Cr component is processed at each stage. After eight such stages, Y0-Y7, Cb0-Cb7, and Cr0-Cr7 are all processed, then each component has been processed in series, but in parallel with each other component. The divisions of Cr 526 and Cb 528 are used to indicate the different parts of the chroma values. In this case there are 8 parts each of Y, Cb, and Cr so that one component of each may be processed in parallel with each other. The processing is complete in 8 stages or clocks or in the amount of time that would be consumed to process only the Y0-Y7 parts on the left side ordering 530.

Note that example 2, as is, does not improve the worst case for intra prediction loop latency, which is a 4:2:0 square PU of size 8×8 with txfm size 4×4 because Cb and Cr must be coded with a single txfm size of 4×4 each. This example is shown in FIG. 3. To improve the intra prediction loop latency for txfm size 4×4 (for luma samples), the Cb and Cr samples may be interleaved as described in example 1, variation (a) (as shown in FIG. 6, right) or variation (b) (as shown in FIG. 9, right). This interleaving can be extended to 4:2:2 and 4:4:4, etc.

As described, Y and Cb/Cr may be interleaved in a very specific sequence, which is reflected in the bit-stream decoded, in the case of a video decoder, or the bit-stream generated, in the case of a video encoder. The described embodiments may be part of a video standard. As described, the intra prediction loop latency is reduced, thus increasing the throughput. This throughput improvement applies to the implementation of video encoders and to video decoders.

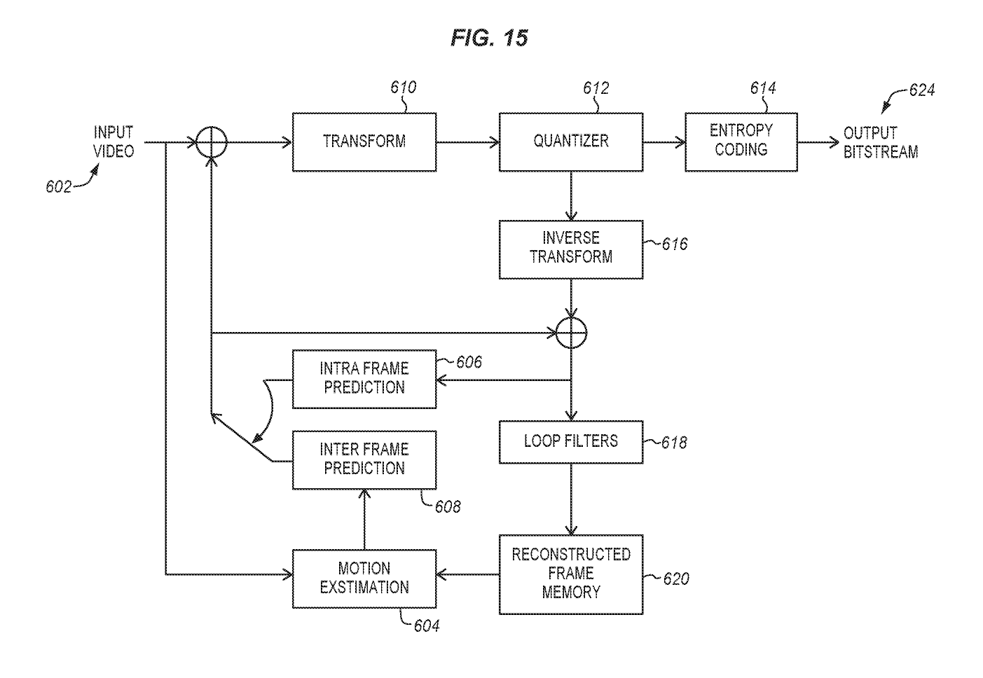

FIG. 15 is a diagram of a generalized encoder architecture in which an input video is subjected to a transform engine and entropy encoding. Intra-frame and Inter-frame prediction may be used based on Y, Cr, and Cb values as described herein. The output bitstream is in the form of encoded video that may be stored, transmitted, or further edited.

In the encoder 600, input video 602 is received and sent to motion estimation. The motion estimation is sent to Inter-frame prediction 608. This prediction is applied to a transform 610 which uses the prediction to encode the input video 602. The transform video is applied to a quantizer 612 and then to entropy encoding 614 to produce an output encoded bitstream 624.

The quantizer output 612 is also applied to an inverse transform 616 for use in Intra-frame prediction 606 which is applied to the transform 610 for further encoding. The inverse transform 616 is applied to loop filters 618 which are connected to a reconstructed frame memory 620 to further refine the motion estimation 604.

In this video encoder case, the samples from the input video 602 are first processed at the transform processing unit 610 and then added to a bit stream. The entropy encoding 614 may include samples to bin/bit processing, such as multi-level or binary entropy encoding. To support the parallel processing of the samples described above, the transform processing unit is changed but any operations after the transform processing unit and before the samples are added to the bit stream is not necessarily affected or changed. Such last processing stages as entropy encoding are also not necessarily changed. Only the order in which samples are input to such a last processing stage is changed. As a result the order of the coefficients in the bit-stream also does not require change.

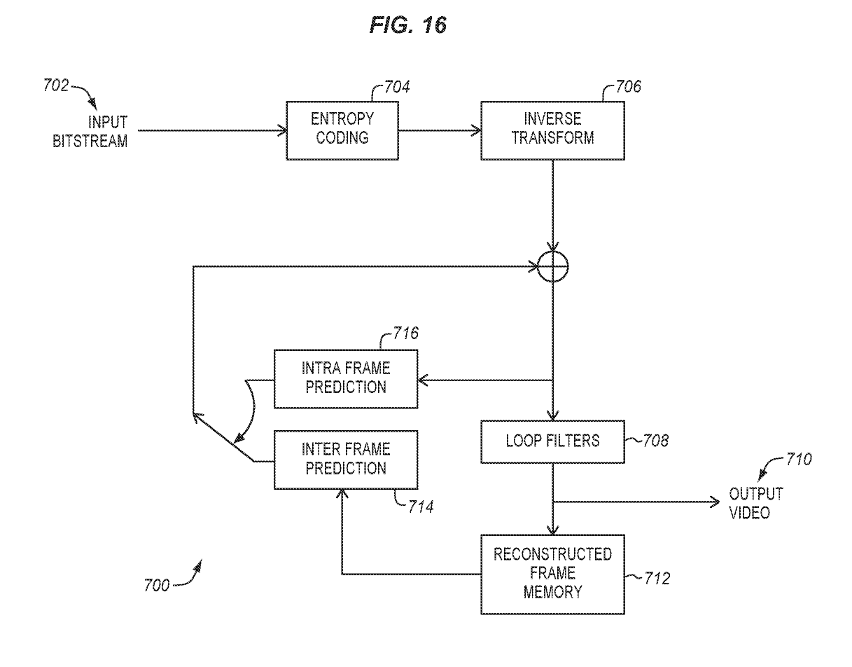

FIG. 16 is a diagram of a generalized decoder architecture in which intra-frame, inter-frame and transform engines are also used as described herein. The input bitstream 702 is an encoded video that is decoded to produce output video 710 for user consumption such as for display.

The input bitstream 702 is applied to entropy decoding 704 and then to an inverse transform 706. This result is refined through loop filters 708 before being supplied as output video 712. Before the loop filter Intra-frame 716 and Inter-frame 714 prediction are applied to the inverse transform video. The Intra-frame prediction uses the output video before filtering. The Inter-frame prediction 714 uses the output filtered video 710 applied through a reconstructed frame memory 712.

In this video decoder, the processing is symmetric to that described above for the video encoder. As a result, the video decoder is neither impacted nor affected by how the samples are processed after being extracted from the bit-stream in the entropy decoder 704 and before being processed by the inverse transform processing unit 706. As with the encoder only the order in which bin/bit are input to the bin/bit-to-samples processing is changed.

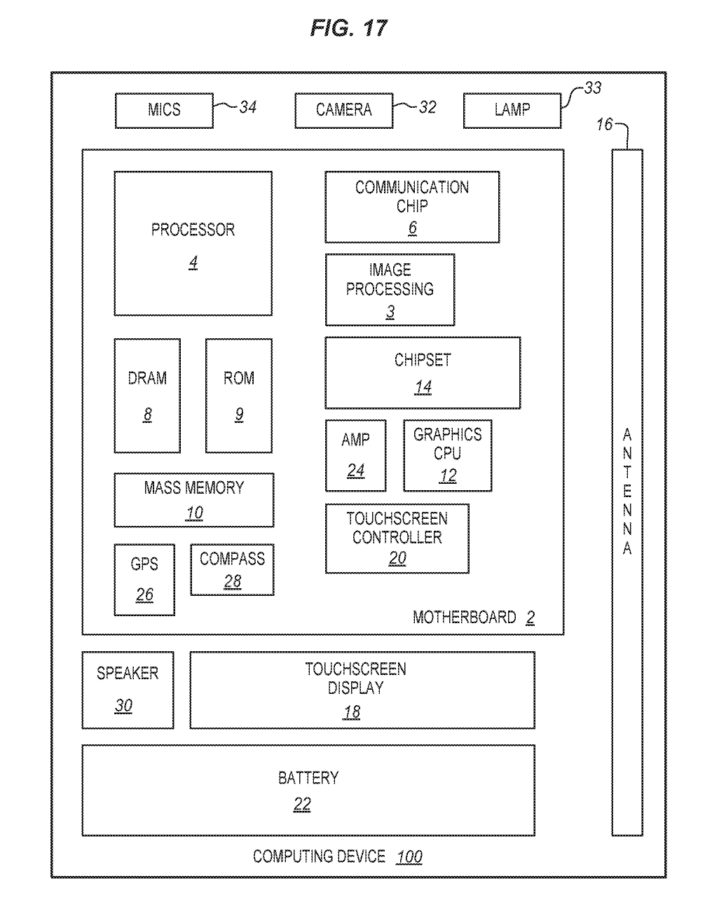

FIG. 17 is a block diagram of a computing device 100 in accordance with one implementation. The computing device 100 houses a system board 2. The board 2 may include a number of components, including but not limited to a processor 4 and at least one communication package 6. The communication package is coupled to one or more antennas 16. The processor 4 is physically and electrically coupled to the board 2.

Depending on its applications, computing device 100 may include other components that may or may not be physically and electrically coupled to the board 2. These other components include, but are not limited to, volatile memory (e.g., DRAM) 8, non-volatile memory (e.g., ROM) 9, flash memory (not shown), a graphics processor 12, a digital signal processor (not shown), a crypto processor (not shown), a chipset 14, an antenna 16, a display 18 such as a touchscreen display, a touchscreen controller 20, a battery 22, an audio codec (not shown), a video codec (not shown), a power amplifier 24, a global positioning system (GPS) device 26, a compass 28, an accelerometer (not shown), a gyroscope (not shown), a speaker 30, a camera 32, a lamp 33, a microphone array 34, and a mass storage device (such as a hard disk drive) 10, compact disk (CD) (not shown), digital versatile disk (DVD) (not shown), and so forth). These components may be connected to the system board 2, mounted to the system board, or combined with any of the other components.

The communication package 6 enables wireless and/or wired communications for the transfer of data to and from the computing device 100. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication package 6 may implement any of a number of wireless or wired standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, Ethernet derivatives thereof, as well as any other wireless and wired protocols that are designated as 3G, 4G, 5G, and beyond. The computing device 100 may include a plurality of communication packages 6. For instance, a first communication package 6 may be dedicated to shorter range wireless communications such as Wi-Fi and Bluetooth and a second communication package 6 may be dedicated to longer range wireless communications such as GPS, EDGE, GPRS, CDMA, WiMAX, LTE, Ev-DO, and others.

The cameras 32 capture video as a sequence of frames as described herein. The image sensors may use the resources of an image processing chip 3 to read values and also to perform exposure control, shutter modulation, format conversion, coding and decoding, noise reduction and 3D mapping, etc. The processor 4 is coupled to the image processing chip and the graphics CPU 12 is optionally coupled to the processor to perform some or all of the process described herein for the video encoding. Similarly, the video playback and decoding may use a similar architecture with a processor and optional graphics CPU to render encoded video from the memory, received through the communications chip or both.

In various implementations, the computing device 100 may be eyewear, a laptop, a netbook, a notebook, an ultrabook, a smartphone, a tablet, a personal digital assistant (PDA), an ultra mobile PC, a mobile phone, a desktop computer, a server, a set-top box, an entertainment control unit, a digital camera, a portable music player, or a digital video recorder. The computing device may be fixed, portable, or wearable. In further implementations, the computing device 100 may be any other electronic device that processes data.

Embodiments may be implemented as a part of one or more memory chips, controllers, CPUs (Central Processing Unit), microchips or integrated circuits interconnected using a motherboard, an application specific integrated circuit (ASIC), and/or a field programmable gate array (FPGA).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims. The various features of the different embodiments may be variously combined with some features included and others excluded to suit a variety of different applications.

The following examples pertain to further embodiments. The various features of the different embodiments may be variously combined with some features included and others excluded to suit a variety of different applications. Some embodiments pertain to a method that includes generating a residual unit of an input video, the residual unit having a predictive unit with luminance samples and transform blocks having chrominance samples, interleaving luminance and chrominance samples of the residual unit, reconstructing the interleaved luminance and chrominance samples in parallel for intra-frame prediction, adding the reconstructed samples to a bitstream of other units generated from the input video, and entropy encoding the bitstream to produce an encoded video bitstream.

In further embodiments generating comprises generating a residual unit in a transform domain and wherein reconstructing is performed in the transform domain.

In further embodiments the residual unit represents a square block of samples processed by a square transform

In further embodiments the square block comprises a 4:2:0 square prediction unit which is larger than the transform block size.

In further embodiments reconstructing comprises processing the samples in parallel with other samples that do not depend on the reconstruction of unprocessed samples.

In further embodiments reconstructing comprises processing luminance samples in parallel with chrominance samples.

In further embodiments interleaving comprises placing a luminance sample followed by a chrominance sample until there are no remaining chrominance samples in the residual unit and wherein reconstructing comprises processing each luminance block of transformed samples followed by a chrominance block of transformed samples and then another luminance block followed by another chrominance block until all of the chrominance blocks have been scanned.

In further embodiments a chrominance block of chrominance samples of the residual unit is paired with each luminance block of samples of the residual unit to be processed in parallel when reconstructing.

In further embodiments a second chrominance block of chrominance samples of the residual unit is also paired with each luminance block.

Some embodiments pertain to a computer-readable medium having instructions thereon, the instructions causing the computer to perform operations that include generating a residual unit of an input video, the residual unit having a predictive unit with luminance samples and transform blocks having chrominance samples, interleaving luminance and chrominance samples of the residual unit, reconstructing the interleaved luminance and chrominance samples in parallel for intra-frame prediction, adding the reconstructed samples to a bitstream of other units generated from the input video, and entropy encoding the bitstream to produce an encoded video bitstream.

In further embodiments reconstructing comprises processing the samples in parallel with other samples that do not depend on the reconstruction of unprocessed samples.

In further embodiments reconstructing comprises processing luminance samples in parallel with chrominance samples.

Some embodiments pertain to an apparatus that includes a memory to store received input video, the video having a plurality of frames each having luminance and chrominance samples, a video encoder coupled to the memory having a transform processing unit to generate a residual unit of an input video, the residual unit having a predictive unit with luminance samples and transform blocks having chrominance samples, to interleave luminance and chrominance samples of the residual unit, and to reconstruct the interleaved luminance and chrominance samples in parallel for intra-frame prediction, an adder to add the reconstructed samples to a bitstream of other units generated from the input video, and an encoder to entropy encode the bitstream to produce an encoded video bitstream.

In further embodiments the residual unit represents a square block of samples processed by a square transform of the transform processing unit.

In further embodiments the square block comprises a 4:2:0 square prediction unit which is larger than the transform block size.

Some embodiments pertain to a method that includes receiving a residual unit of an encoded video bitstream, the residual unit having a predictive unit with luminance samples and transform blocks having chrominance samples, interleaving luminance and chrominance samples of the residual unit, reconstructing the interleaved luminance and chrominance samples in parallel for intra-frame prediction, adding the reconstructed samples to a bitstream of other units generated from the input video, and performing an inverse transform of the bitstream to produce a decoded video.

In further embodiments the residual unit represents a square block of samples processed by a square transform

In further embodiments the square block comprises a 4:2:0 square prediction unit which is larger than the transform block size.

In further embodiments interleaving comprises placing a luminance sample followed by a chrominance sample until there are no remaining chrominance samples in the residual unit and wherein reconstructing comprises processing each luminance block of transformed samples followed by a chrominance block of transformed samples and then another luminance block followed by another chrominance block until all of the chrominance blocks have been scanned.

In further embodiments a chrominance block of chrominance samples of the residual unit is paired with each luminance block of samples of the residual unit to be processed in parallel when reconstructing.

Some embodiments pertain to an apparatus that includes means for generating a residual unit of an input video, the residual unit having a predictive unit with luminance samples and transform blocks having chrominance samples, means for interleaving luminance and chrominance samples of the residual unit, means for reconstructing the interleaved luminance and chrominance samples in parallel for intra-frame prediction, means for adding the reconstructed samples to a bitstream of other units generated from the input video, and means for entropy encoding the bitstream to produce an encoded video bitstream.

In further embodiments the means for reconstructing processes the samples in parallel with other samples that do not depend on the reconstruction of unprocessed samples.

In further embodiments the means for reconstructing processes luminance samples in parallel with chrominance samples.

What is claimed is:

1. A method comprising:
generating a residual unit of an input video, the residual unit having a predictive unit with luminance samples and transform blocks having chrominance samples;
interleaving luminance and chrominance samples of the residual unit;
reconstructing the interleaved luminance and chrominance samples in parallel for intra-frame prediction;
adding the reconstructed samples to a bitstream of other units generated from the input video; and
entropy encoding the bitstream to produce an encoded video bitstream.

2. The method of claim 1, wherein generating comprises generating a residual unit in a transform domain and wherein reconstructing is performed in the transform domain.

3. The method of claim 1, wherein the residual unit represents a square block of samples processed by a square transform.

4. The method of claim 3, wherein the square block comprises a 4:2:0 square prediction unit which is larger than the transform block size.

5. The method of claim 1, wherein reconstructing comprises processing the samples in parallel with other samples that do not depend on the reconstruction of unprocessed samples.

6. The method of claim 1, wherein reconstructing comprises processing luminance samples in parallel with chrominance samples.

7. The method of claim 1, wherein interleaving comprises placing a luminance sample followed by a chrominance sample until there are no remaining chrominance samples in the residual unit and wherein reconstructing comprises processing each luminance block of transformed samples followed by a chrominance block of transformed samples and then another luminance block followed by another chrominance block until all of the chrominance blocks have been scanned.

8. The method of claim 1, wherein a chrominance block of chrominance samples of the residual unit is paired with each luminance block of samples of the residual unit to be processed in parallel when reconstructing.

9. The method of claim 8, wherein a second chrominance block of chrominance samples of the residual unit is also paired with each luminance block.

10. A computer-readable medium having instructions thereon, the instructions causing the computer to perform operations comprising:
generating a residual unit of an input video, the residual unit having a predictive unit with luminance samples and transform blocks having chrominance samples;
interleaving luminance and chrominance samples of the residual unit;
reconstructing the interleaved luminance and chrominance samples in parallel for intra-frame prediction;
adding the reconstructed samples to a bitstream of other units generated from the input video; and
entropy encoding the bitstream to produce an encoded video bitstream.

11. The medium of claim 10, wherein reconstructing comprises processing the samples in parallel with other samples that do not depend on the reconstruction of unprocessed samples.

12. The medium of claim 10, wherein reconstructing comprises processing luminance samples in parallel with chrominance samples.

13. An apparatus comprising:
a memory to store received input video, the video having a plurality of frames each having luminance and chrominance samples;
a video encoder coupled to the memory having
a transform processing unit to generate a residual unit of an input video, the residual unit having a predictive unit with luminance samples and transform blocks having chrominance samples, to interleave luminance and chrominance samples of the residual unit, and to reconstruct the interleaved luminance and chrominance samples in parallel for intra-frame prediction;
an adder to add the reconstructed samples to a bitstream of other units generated from the input video; and
an encoder to entropy encode the bitstream to produce an encoded video bitstream.

14. The apparatus of claim 13, wherein the residual unit represents a square block of samples processed by a square transform of the transform processing unit.

15. The apparatus of claim 14, wherein the square block comprises a 4:2:0 square prediction unit which is larger than the transform block size.

16. A method comprising:
receiving a residual unit of an encoded video bitstream, the residual unit having a predictive unit with luminance samples and transform blocks having chrominance samples;
interleaving luminance and chrominance samples of the residual unit;
reconstructing the interleaved luminance and chrominance samples in parallel for intra-frame prediction;
adding the reconstructed samples to a bitstream of other units generated from the input video; and
performing an inverse transform of the bitstream to produce a decoded video.

17. The method of claim 16, wherein the residual unit represents a square block of samples processed by a square transform.

18. The method of claim 17, wherein the square block comprises a 4:2:0 square prediction unit which is larger than the transform block size.

19. The method of claim 16, wherein interleaving comprises placing a luminance sample followed by a chrominance sample until there are no remaining chrominance samples in the residual unit and wherein reconstructing comprises processing each luminance block of transformed samples followed by a chrominance block of transformed samples and then another luminance block followed by another chrominance block until all of the chrominance blocks have been scanned.

20. The method of claim 16, wherein a chrominance block of chrominance samples of the residual unit is paired with each luminance block of samples of the residual unit to be processed in parallel when reconstructing.
